(19) United States
(12) Patent Application Publication
(10) Pub. No.: US 2008/0143868 A1
(43) Pub. Date: Jun. 19, 2008

(54) CAMERA MODULE

(75) Inventors: Masaki Tsuchiya, Tokyo (JP); Kazutaka Motohashi, Tokyo (JP); Fumio Watanabe, Tokyo (JP); Toshitaka Sakimura, Tokyo (JP)

Correspondence Address: DARBY & DARBY P.C., P.O. BOX 770, Church Street Station, New York, NY, 10008-0770, US

(73) Assignee: SMK CORPORATION, Tokyo (JP)

(21) Appl. No.: 11/854,081

(22) Filed: Sep. 12, 2007

(30) Foreign Application Priority Data
Dec. 18, 2006 (JP) JP2006-340135

(51) Int. Cl. H04N 5/225; G03B 7/00

(52) U.S. Cl. 348/360; 396/241; 348/E05.024

(57) ABSTRACT

A camera module for imaging a plurality of types of light such as visible light and infrared light with a single lens unit and sensor unit. The camera module includes a lens unit and a housing capable of attaching the lens unit so that it is in opposition to a photosensitive element. A filter unit, in which there are disposed a plurality of light cut filters having different wavelengths is disposed between the lens unit and the photosensitive element or outside of the lens unit. A filter positioning device passes imaging light from a photographic subject through a desired light cut filter in the filter unit before the imaging light reads the photosensitive element.

### CROSS-REFERENCE TO RELATED APPLICATION

The present application claims priority under 35 U.S.C. §119 to Japanese Patent Application No. 2006-340135, filed Dec. 18, 2006, and which is hereby incorporated herein by reference in its entirety.

### FIELD OF THE INVENTION

The present invention relates to a camera module, and more specifically to a camera module that is usable in mobile phones and the like, that is reduced in size and is capable of imaging with visible light or other, non-visible light.

### BACKGROUND OF THE INVENTION

Conventionally, camera modules used in small electronic equipment such as mobile telephones are small (1 cm per side) and are provided with an internal lens unit and a photosensitive element. The light passing through the lens unit is collected on the photosensitive element in order for imaging to be carried out.

As is shown in FIG. 21, a small camera module 100 installed in electronic equipment such as a mobile telephone with a camera comprises a lens module 101 with an internally installed lens, an intermediate part 102 provided on the outside of the lens module 101, and a pedestal 103 on which the intermediate part 102 is attached.

The lens module 101 has a cylindrical shape, and lens L1 and lens L2 are installed on the inside of the lens module 101. A screw thread 104 is provided on the exterior cylindrical surface of the lens module 101.

The intermediate part 102 is a ring-shaped part, and the inside cylindrical surface of intermediate part 102 is provided with a screw thread 105 that screws together with screw thread 104 of the lens module 101. Furthermore, a screw thread 106 is provided on the outside of the intermediate part 102.

A pedestal 103 is provided with a cylindrical space provided with a screw thread 107 that can be screwed together with the screw thread 106 on the intermediate part 102, and a light receiving unit 108 is secured to the base of the pedestal 103.

During the manufacturing process for the camera module 100, the attachment position for the intermediate part 102 is adjusted by the screw threads 106 and 107 that screw together the pedestal 103 and the intermediate part 102, so that the focus adjusted so that a focused image from the lens module 101 is formed on the light receiving unit 108.

Furthermore, in the camera module 100, a band-pass filter may be provided that is capable of transmitting selected wavelengths of the imaging light to the surface of the light receiving unit 108, or a low-pass filter or a high pass filter may be provided that cuts the wavelengths above or wavelengths below a desired wavelength, is provided for transmitting the target imaging light.

In the conventional camera module 100 constituted as described above, and in other camera modules with other constitutions that are capable of imaging wavelengths in a single spectral range, there is the problem of needing multiple camera modules for each desired range, (for example, normal imaging using visible light and nighttime imaging and the like using infrared light). This problem causes can increase as the volume of camera modules placed into extremely small electronic devices such as mobile telephones, thereby increasing the size of the electronic devices such themselves. In addition to inhibiting the further miniaturization of electronic equipment, this problem also effects the pricing of these products.

Furthermore, since the two camera modules must be switched and imaging done, there must be a device and program for switching the camera modules, which further negatively affects reductions in size and reductions in cost.

### SUMMARY OF THE INVENTION

Therefore, in light of the problems described above, the present invention provides a camera module that switches imaging in a style camera module for two or more imaging light ranges.

A camera module comprises a lens unit with an internal lens that refracts light that enters a light-receiving surface of the lens and passes it through to an opposing surface of the leases and a housing having a photosensitive element in its base part with the lens unit attachable so as to be in opposition with the photosensitive element. A filter unit, in which there is disposed a plurality of adjacent light cut filters with different cut wavelengths, is disposed between the lens unit and the photosensitive element or alternatively on the opposite side of the lens unit from the photosensitive element along with the filter unit being provided with a filter moving device capable of moving the filter unit, and the filter moving device is capable of switching filters such that the imaging light reaching the photosensitive element from a photographic subject passes through a selected light cut filter that is called for out of those filters in the filter unit.

In the inventive camera module, a filter unit with adjacent light filters that allow different types of light to pass through is disposed between the photosensitive element and the lens unit or on the opposite side of the lens unit from the photosensitive element. In other words, it is provided in the imaging light path before the lens or after the lens as viewed from the photosensitive element.

When, for example, the filter unit is made up of an infrared light imaging filter that cuts out wavelengths of the visible range and below and a visible light imaging filter that cuts out wavelengths longer than the wavelengths of infrared light, the light reaching the photosensitive element via the lens unit has infrared light reaching the photosensitive element with the infrared light imaging filter, and visible light and ultraviolet light reaching the photosensitive element with the visible light imaging filter. Therefore, the imaging light going to the photosensitive element from the imaging target is switched to the visible light imaging filter or the infrared light imaging filter by the filter moving device that moves the filter unit to each position using a slide movement, a rotary movement or the like, and the light corresponding to the characteristics of each filter is imaged accordingly.

Thus, imaging light of desired wavelengths is imaged by having different light transmittance characteristics in the multiple light filters provided in the filter unit.

In addition, to improve the switching speed and stability when switching among the multiple filters, the constitution is such that the light cut filter described previously is a thin plate having a rectangular shape, and the adjacent light cut filters are arranged to be continuous with each other on long side of the rectangular filters. As a result, switching is completed with moving the distance of the short side, and switching responsiveness improved.

Furthermore, to solve the problem of a difference in focal distance arising when the imaging target passes through the lens unit and reaches the photosensitive element due to a different refraction according to the wavelengths of the imaging light when the filters are provided between the lens unit and the photosensitive element in the present invention, a camera module may be provided where the light cut filters are constituted such that a difference in focal distance to the photosensitive element is provided according to the difference in wavelength for each of ultraviolet light, visible light and infrared light by differences in the thickness of the filters. Or a camera module where the light cut filters are constituted such that a difference in focal distance to the photosensitive element is provided according to the difference in wavelength for each of ultraviolet light, visible light and infrared light by differences in the constituent materials for the filters. In the present invention, the index of refraction when passing through the light cut filters varies according to the wavelength of the light, and there is the problem of an offset in the focal distance occurring between the lens unit and the photosensitive element. However, by having the light cut filters be of different materials or making the thickness of the constituent filters different, it is possible to adjust the focal distance through a difference in index of refraction and to reach the photosensitive element with the same focal distance. By this means, the camera module is capable of imaging with the same focal distance even if the light being imaged is out of a different type, namely a different wavelength.

The camera module constituted as described above has the inventive and novel effect of being able to switch and use light cut filters that differ in the frequency of the light that is cut on the outside or the inside of the lens unit on an image with various types of light, specifically ultraviolet light, visible light and infrared light with a single camera module.

Furthermore, by making this switching possible, there is also the effect of an application in conventional camera modules being possible when the filters and switching devices are provided on the outside of the lens unit by using the case on the outside of the conventional camera module and by providing a filter unit and a filter moving on the case to switch the filter unit within the case.

In addition, in one where the filter unit is provided between the lens unit and the photosensitive element, the camera module may be constituted using a new design. By having the filter unit and filter moving means in a space that was open and not directly used for imaging in the conventional camera module, constitution of the present invention in a volume equal to that of conventional camera modules or a volume slightly larger is possible, and there is the effect of being able to reduce the size of camera modules capable of imaging multiple wavelengths of light.

In addition, a minimal light cut filter movement distance may be used, for example, since adjacent rectangular light cut filters may be provided that are connected with each other on the long side.

Furthermore, by changing the thickness of the light cut filters or the material that forms the base material for the filters, the index of refraction for the light may be changed, and adjustments may be made for the variable offsetting in focal distance according to the wavelengths of the light.

### BRIEF DESCRIPTION OF THE DRAWINGS

The invention will become more readily apparent from the Detailed Description of the Invention, which proceeds with reference to the drawings, in which:

FIG. 1 is a perspective drawing showing an embodiment of the present inventions.

FIG. 2 is a plan view drawing of the embodiment of FIG. 1.

FIG. 3 is a cross-sectional drawing through line A-A of FIG. 2.

FIG. 4 is a perspective exploded drawing of the embodiment of FIG. 1.

FIG. 5 is a bottom view explanatory drawing of the embodiment of FIG. 1.

FIG. 6 provides a graph illustrating difference in focal distance according to wavelength.

FIG. 7(a) and 7(b) is a drawing that explains the adjustment of the focal distance, where FIG. 7(a) shows the state where the focal distance is not adjusted from a while FIG. 7(b) shows the state where the focal distance is adjusted.

FIG. 8 is a perspective drawing showing and the embodiment of the present inventions.

FIG. 9 is a plan view drawing of the embodiment of FIG. 8.

FIG. 10 is a cross-sectional drawing through the line B-B of FIG. 9.

FIG. 11 is a perspective exploded drawing showing of the embodiment of FIG. 2.

FIG. 12 is a perspective exploded drawing of the embodiment of FIG. 2.

FIG. 13 is a perspective exploded drawing showing another embodiment of the present inventions.

FIG. 14 is a plan view drawing of the embodiment of FIG. 13.

FIG. 15 is a cross-sectional drawing through the line D-D of FIG. 14.

FIG. 16 is a perspective explanatory drawing showing yet another embodiment of the present inventions.

FIG. 17 is a plan view drawing of the embodiment of FIG. 16.

FIG. 18 is a cross-sectional explanatory drawing through the line E-E in FIG. 17.

FIG. 19 is a front view drawing of the embodiment of FIG. 16.

FIG. 20 is a perspective exploded drawing of the embodiment of FIG. 16.

FIG. 21 is a cross-sectional drawing showing a conventional camera module.

### DETAILED DESCRIPTION OF THE INVENTION

The following table provides a key to the reference elements used in the drawings:

| | |
|---|---|
| 1 | camera module |
| 11 | housing |
| 11a | upper surface |
| 11b | attachment hole |
| 12 | slide groove |
| 13 | actuator installation part |
| 14a | free play allowing hole |
| 14b | free play allowing hole |
| 2 | lens unit |
| 21 | barrel |
| 22 | incident light hole |
| 23 | lens |
| 24 | lens |
| 3 | image sensor unit |
| 31 | image sensor |
| 32 | base part |
| 4 | tightly sealing cover |
| 41 | tightly sealing cover main body |
| 42 | light transmitting when |
| 43 | tightly sealing glass |
| 5 | filter unit |
| 51 | filter unit main body |
| 52 | light filter |
| 52a | infrared range like cutting filter |
| 52b | visible range like cutting filter |
| 53 | actuator |
| 54 | installation hole |
| 55 | securing protruding part |
| 56 | sliding protrusion |
| 57 | standing wall |
| 58 | latching protrusion |
| 59 | attachment part |
| 6 | camera unit |
| 61 | lens module |
| 62 | pedestal |
| 63 | lens |
| 64 | lens |
| 65 | light receiving unit |
| 7 | motor |
| 71 | gear |
| 72 | rotary shaft |
| 8 | gear unit |
| 81 | unit main body |
| 82 | circumferential gear |
| 83 | center hole |
| 84 | installation hole |
| 9 | pin |
| 10 | |
| 104 | screw thread |
| 105 | screw thread |

Accordingly, to the principles of the present invention, a camera module comprises a lens unit, a housing and a filter unit. The lens unit for the camera module includes a case, comprising for example a polymer resin that is black or dark color and formed in a cylindrical shape, and a lens. A light path is formed between two side surfaces of the lens unit.

The housing includes an attachment hole in an upper part of the housing into which the cylindrical shaped lens unit can be inserted. In addition, a light receiving part is secured to a base surface of the housing, and the photosensitive element is secured in an attachment hole for the light receiving part. The photosensitive element is an element typically used for visible light imaging, and typically includes color filter placed at the bottom of a micro-lens so that each of the three primary colors of the light may be imaged. This color filter typically has peaks in the visible light range corresponding to each of the colors and in the infrared range.

A tightly sealing cover that prevents dust and the like from settling on the upper surface of the photosensitive element and affecting the imaging is provided on the upper part of the photosensitive element in the housing. Along with the tightly sealing cover, a tightly sealing glass is inserted on a surface positioned on the upper surface opposed to the photosensitive element, that is, between the lens unit and the photosensitive element, so that light transmittance is possible. The cover covers the other parts in a lid shape so as to tightly seal the photosensitive element.

The filter unit is provided between the tightly sealing glass of the tightly sealing cover and the lens unit. The filter unit comprises a main filter unit for attaching a light filter where there are for example two types of light filters having specific wavelengths for the imaging light that reaches the photosensitive device via the lens unit, and an actuator for moving the main filter unit and operating the switching of the light filters positioned between the photosensitive element and the lens unit.

The filter unit may provide an infrared range light cutting filter that cuts out wavelengths of 650 (nm) or greater and allows imaging of visible light, and a visible light range light cutting filter that cuts out wavelengths of 700 (nm) and allows imaging infrared light, in proximity to each other. The light filters may have a thin plate shape that is a rectangle in a plane view, and a long side of each of the light filters may be provided in proximity to another filter as they are secured to the main filter unit.

The actuator for moving the filters may be formed from a piezo actuator that uses the piezo effect, to which one part of the end edge of the main filter unit is secured and supported. When there is expansion or contraction because of the piezo effect, the light filter that is currently in the light path for the imaging light between the lens unit and the photosensitive element is switched to the other light filter.

The filter unit constituted in this manner is confirmed in the camera module housing so that voltage may be supplied to the piezo actuator.

Several embodiments of the this invention are now described with reference to the drawings.

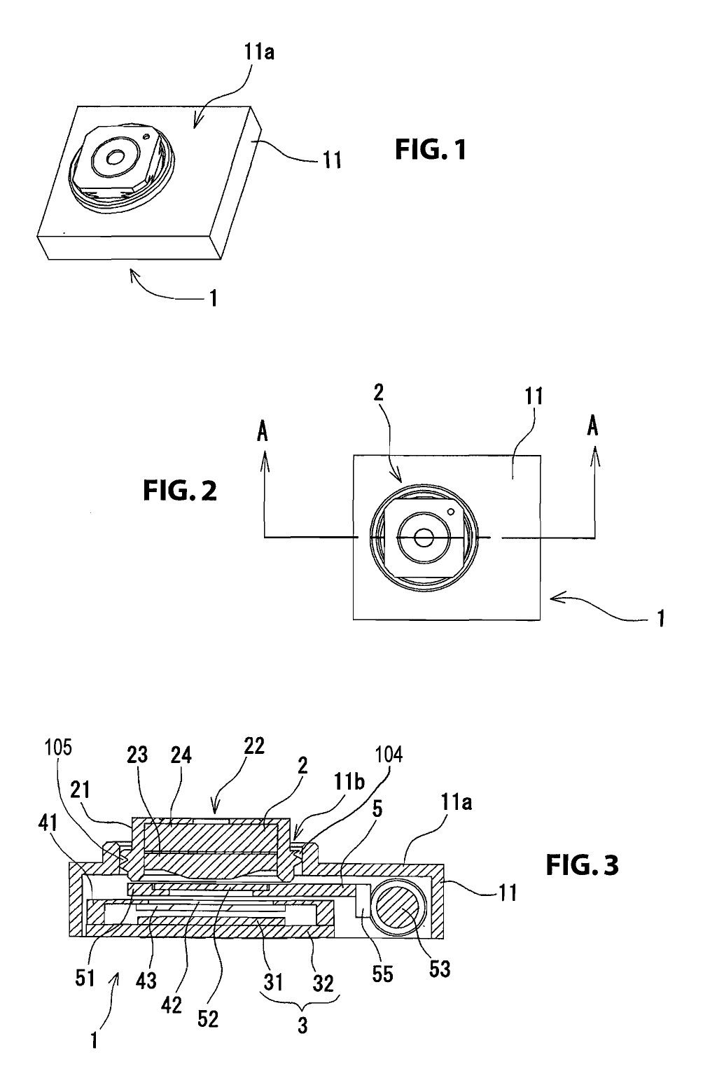

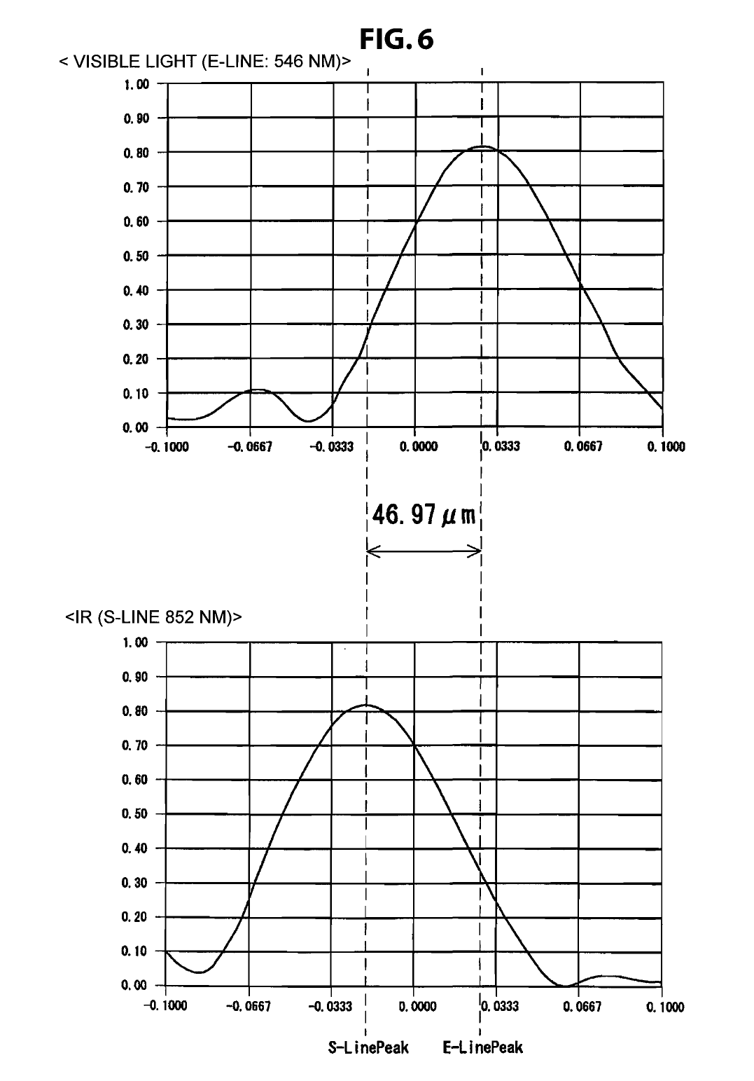

Element 1 of FIG. 1 is a camera module containing a filter unit. As is shown in FIG. 1 through FIG. 5 according to a first embodiment of the present invention, the camera module 1 has a lens unit 2 inserted and secured in an attachment hole 11b formed in the upper surface 11a of a housing 11 formed in a cylindrical shape and opened on the lower surface. An image sensor unit 3 that is a photosensitive element that receives imaging light that passes through the lens unit 2 is secured and provided on the lower surface of the inside part to the housing 11 and opposed to the lens unit 2. Furthermore, the image sensor unit 3 is provided with a tightly sealing cover 4, and a filter unit 5 having light filters positioned between the tightly sealing cover 4 and the lens unit 2.

The housing 11 may be formed from a black polymer resin so that light is not reflected inside the camera module 1, and the attachment hole 11b that is formed in the upper surface may be provided with a female screw thread 105 that mates with a male screw thread 104 provided helically on the outer surface of the lens unit 2, which is formed in a cylindrical shape, to secure the lens unit 2 to the housing 11. In addition, in this embodiment, a provisions is provided is on the lower surface of the housing 11 in particular, but protrusions and the like are provided for securing and attaching the camera module 1 to an electronic circuit board (not shown in the drawings) to the peripheral part of the lower surface of the housing 11. Furthermore, a base part 32 for the image sensor unit 3 and a fastening part (not shown in the drawings) are provided so that the relative position with the image sensor unit 3 disposed on the lower surface of the housing 11 is not offset, and the image sensor unit 3 is fastened and secured and the relative position determined. In this manner, the operation of attaching the image sensor unit 3 to the housing 11 may be carried out easily.

The attachment hole 11b in the housing 11 may be formed in a position offset from the center of the upper surface 11a of the housing 11. A filter part and a drive part that form the filter unit 5 that is positioned between the lens unit 2 and the image sensor unit 3 is positioned to be adjacent, and since the filter part is provided so as to be positioned between the lens unit 2 and the image sensor unit 3, the lens unit 2 is provided in a position offset from the center of the upper surface 11a. Because of this, the surface area of the housing 11 may be reduced, and the size of the camera module 1 may be reduced.

The lens unit 2 may be provided with a lens 23 and a lens 24 in a hollow barrel 21 formed from a substantially cylindrical shape formed of polymer resin that is black or a deep color near black. An incident light hole 22 is formed on the upper surface of one side surface of the barrel 21. The lens unit 2 refracts the light that enters from the incident light hole through the lens 23 and the lens 24, and forms a light path to the image sensor unit 3 provided on the base surface side of the housing 11.

Moreover, there may be provided a position adjustment mechanism capable of vertically adjusting the position of the lens unit 2 with the housing 11 where the lens unit 2 and the lens unit 2 are provided, and there may be a configuration that is switchable between normal imaging and macro imaging. In other words, the distance between the focus lens unit 2 and the image sensor unit 3 may be made adjustable, and a position adjustment mechanism capable of reducing the focal distance and changing the focal distance during macro imaging may be provided.

The image sensor unit 3 secures an image sensor 31 on a base part 32 formed from a small electronic circuit board held in the base part of the housing 11. The image sensor 31 may be formed from a CMOS device or a CCD, which are small camera image sensors that are typically used, and preferably is in a thin plate shape forming a rectangle from a long side and a short side. A microlens is provided on the upper surface of the image sensor 31, and a color filter capable of dividing the light into the three primary colors and imaging is formed on the bottom part of the microlens. In this manner, the light can be imaged for each of the three primary colors. This color filter preferably has peaks in the visible light range corresponding to each of the colors, and in a infrared range.

The tightly sealing cover 4 is provided with a tightly sealing cover main body 41 formed in a box shape with an opening in the bottom such that it surrounds the image sensor unit 3. The tightly sealing cover main body 41 is preferably formed from a darkly colored polymer resin. A light transmitting window 42 is formed in the upper surface of the tightly sealing cover main body 41, so that light may be transmitted. Furthermore, the bottom part of the light transmitting window 42 secures a tightly sealing glass 43 preferably formed from a transparent glass body. At this time, the hole is formed so that the imaging light passing through the lens unit 2, which is positioned on top of the light transmitting window 42, may reach the image sensor 31.

The tightly sealing cover 4 is applied so as to cover the image sensor 31 on the base part 32 of the image sensor unit 3. Secured and tightly sealed to the image sensor 31, the cover 4 prevents contamination and the like from resting on the image sensor 31 without inhibiting imaging. In particular, the tightly sealing cover 4 completely seals the image sensor 31.

The filter unit 5 comprises a filter unit main body 51, a light filter 52 that is disposed in the filter unit main body 51 and transmits the desired light and an actuator 53 that is a drive means that moves the filter unit main body 51. The filter unit main body 51 is preferably formed as a substantially plate shaped body of darkly colored polymer resin, and an installation hole 54 for installing and securing the light filter 52 is formed in the center part. In addition, a securing protruding part 55 is provided on the filter unit main body 51 for securing the filter unit main body 51 to the actuator 53. The securing protruding part 55 may just be secured by adhering to the actuator 53, or a protruding part (not shown in the drawings) that protrudes may be joined with a latching hole (not shown in the drawings) formed in the actuator 53 and secured by inserting the providing part into the latching hole, or by another method of securing selected appropriately.

The light filter 52 is preferably formed in a plate shape, and has an infrared range light cutting filter 52a for visible light imaging and a visible range light cutting filter 52b secured in a parallel arrangement in the installation hole 54 of the filter unit main body 51. The infrared range light cutting filter 52a, for example, cuts out light with wavelengths at or above 650 (nm), and is a light filter that allows imaging of visible light. The visible range light cutting filter 52b cuts out light with wavelengths at or below 700 (nm), and is a light filter that allows imaging of infrared light. These light filters 52a and 52b are each formed from thin rectangular plates in a similar or substantially similar shape to the image sensor 31 and, when positioned in the light path for imaging light between the lens unit 2 and the imaging sensor 31 (simply “in the light path” in the following), are preferably provided so that the long side X and the short side Y are each oriented to correspond to the shape of the image sensor 31. Furthermore, the light filters 52a and 52b are preferably disposed so that a long side X for each is in contact with that of the other.

By arranging these light filters 52a and 52b in parallel in this manner, it is possible to shorten the distance they move when each of the light filters 52a and 52b is moved by the actuator 53 over the image sensor 31.

Moreover, in this embodiment, the infrared range light cutting filter 52a and the visible range light cutting filter 52b are set for the light filters 52 for making imaging of visible light and infrared light possible in the camera module 1, but imaging may be made possible for visible light and ultraviolet light or infrared light and ultraviolet light, and in these cases, a light filter 52 that makes imaging possible for light of each of the wavelengths may be used, with the selection and use made suitably. Furthermore, there may be a constitution with three or more optical filters 52 arranged in parallel with movement and control of the actuator 53 possible for positioning each in the light path, and furthermore, a camera module 1 capable of imaging a plurality of wavelength ranges may be provided and constituted in this manner.

In this embodiment, the infrared range light cutting filter 52a and the visible range light cutting filter 52b are formed for example from identical transparent resin material. By giving each of them light transmittance capable of cutting the light in the infrared range or higher or in the visible light range or lower, it is possible to image light in a wavelength range corresponding to infrared light or visible light. However, since the index of refraction of the light filters 52 made from the same material varies according to whether the wavelengths of the light passing through are in the infrared range, the visible range or the ultraviolet range, a difference in the focal length arises where the light filters 52 are of the same thickness, and good imaging by the image sensor 31 cannot be carried out. FIG. 6 illustrate this difference in focal distance. In FIG. 6 the horizontal axis for both the upper and lower graphs shows the focus position, and the vertical axis shows the sensitivity to received light for the image sensor 31. The sensitivity to receive the light is measured at each position when the focal distance is gradually moved. Furthermore, the upper graph shows the focal distances for visible light with a wavelength of 546 (nm), and the lower graph shows the focal distance for infrared light with a wavelength of 852 (nm). As can be understood from the upper and lower graphs, there is an offset of roughly 46.97 (μm) at the peaks for the visible light and the infrared light. In other words, the focal distance is at a roughly 46.97 (μm) offset.

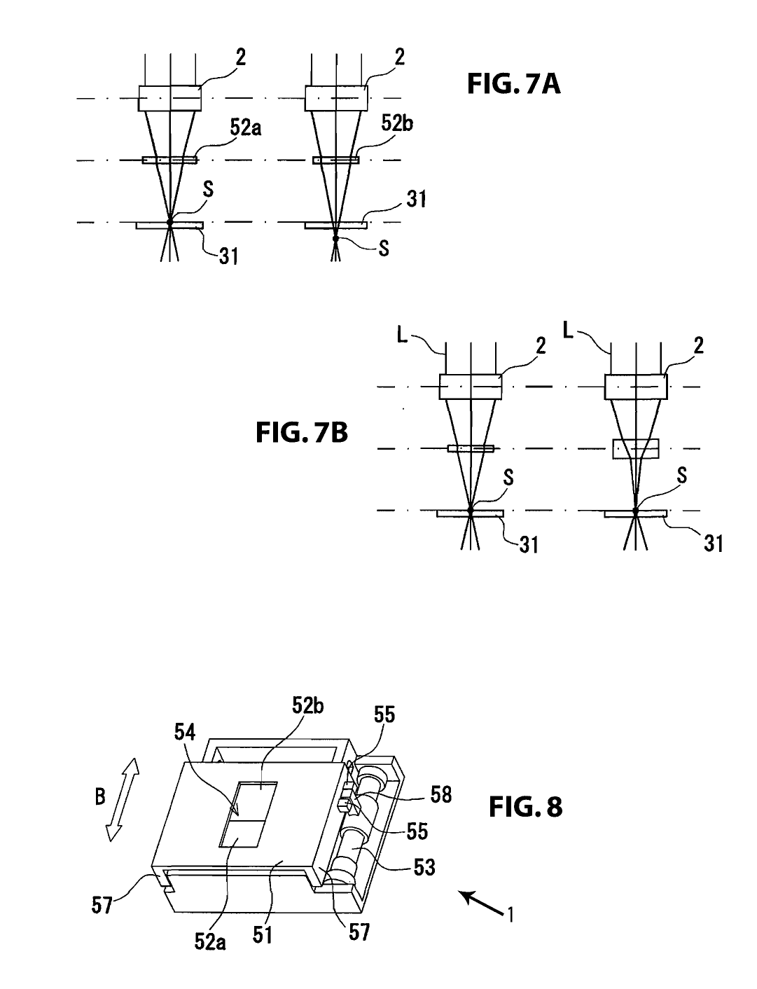

The fact that the light filters 52 that arbitrate in the light path also refract the light is used to adjust this difference in focal distances, and the adjustment is made by changing the thickness of the infrared range light cutting filter 52a and the visible range light cutting filter 52b. FIGS. 7(a) and 7(b) shows the principle for this. FIG. 7(a) shows the offset in a focal point S that occurs when the thickness is of the infrared range light cutting filter 52a and visible range light cutting filter 52b are the same. FIG. 7(b) shows the state where the light path is changed by the refraction from the light filters 52 by changing the thickness of the infrared range light cutting filter 52a and the visible range light cutting filter 52b and the focal point S is aligned on the upper surface of the image sensor 31. In FIG. 7(a) the thicknesses of the infrared range light cutting filter 52a and the visible range light cutting filter 52b are the same, so the focal point S with one of the light filters 52 is positioned on the image sensor 31 and the focal point S for the other light filter 52 is offset from the image sensor 31 because of a small change in the path of the light when refracted and passed through by each of the light filters 52. Conversely, by making one of the light filters 52 thicker, thinner or the like for the adjustment, the focal point distance is changed by the refractive effect of the light filters 52 on the light path, and the focal points S are aligned on the image sensor 31.

The offsetting of the focal points S in the embodiment described above may be adjusted by changing the thickness because infrared range light cutting filter 52a and the visible range light cutting filter 52b are made of the same material. Alternatively, the infrared range light cutting filter 52a and the visible range light cutting filter 52b may be formed from materials with different indices of refraction in order to adjust the focal points S adjusted as described above. The adjustment may also be accompanied by varying both the thickness and the index of refraction.

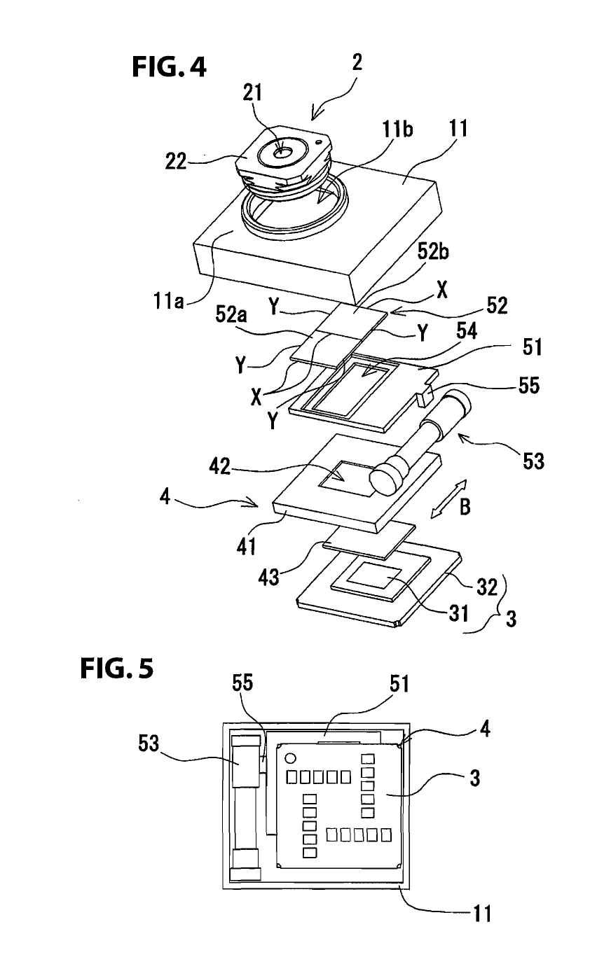

In the present embodiment, the actuator 53 is formed by a piezo actuator that uses the piezo effect and secures and supports the filter unit main body 51 protruding part 55. When the actuator 53 expands or contracts because of the piezo effect, the filter unit main body 51 slides and moves as in arrow B shown in FIG. 4 so that the infrared range light cutting filter 52a, which is positioned in the light path in the initial state, moves to the visible range light cutting filter 52b. In addition, even though it is not described in detail herein, the voltage applied to the actuator 53 is suitably by naturally set a separate electronic circuit, and the electrical connection with the actuator 53 suitably formed in the same manner as conventionally used with the piezo actuator 53.

In the following, the operation of Embodiment 1, which is constituted as described above, will be described.

The actuator 53 places the infrared range light cutting filter 52a in the light path in the initial state, so that imaging using visible light is possible. In this state, the imaging light is transmitted and refracted in the lens unit 2 and enters the camera module 1. Furthermore, it passes through the infrared range light cutting filter 52a and the tightly sealing glass 43 of the tightly sealing cover 4, and is focused on the image sensor 31 and imaged.

When carrying out imaging with infrared light using the visible range light cutting filter 52b after imaging with visible light using the infrared range light cutting filter 52a, the actuator 53 moves the light filter unit main body 51 as in arrow B shown graphically in FIG. 4 when the actuator 53 is operated by a conventional switch or the like so that the light filter 52 position on the light path goes from the infrared range light cutting filter 52a to the visible range light cutting filter 52b.

Since the infrared range light cutting filter 52a and the visible range light cutting filter 52b are provided in contact with each other on the long side, the filter unit main body 51 that is moved at this time may complete its movement if it is just moved the distance of the short side.

When the move is made so that the visible range light cutting filter 52 is in the light path, the image light passes through and is refracted by the lens unit 2 in the same manner as described above and enters the camera module 1 and next is refracted by the visible range light cutting filter 52b of the filter unit 5. The focal distance is adjusted by the refraction at this time, and the image light that exits the visible range light cutting filter 52b is focused at the focal point S on the image sensor 31 via the tightly sealing glass 43 and forms a good image.

Another embodiment of this invention will be described with reference to the drawings.

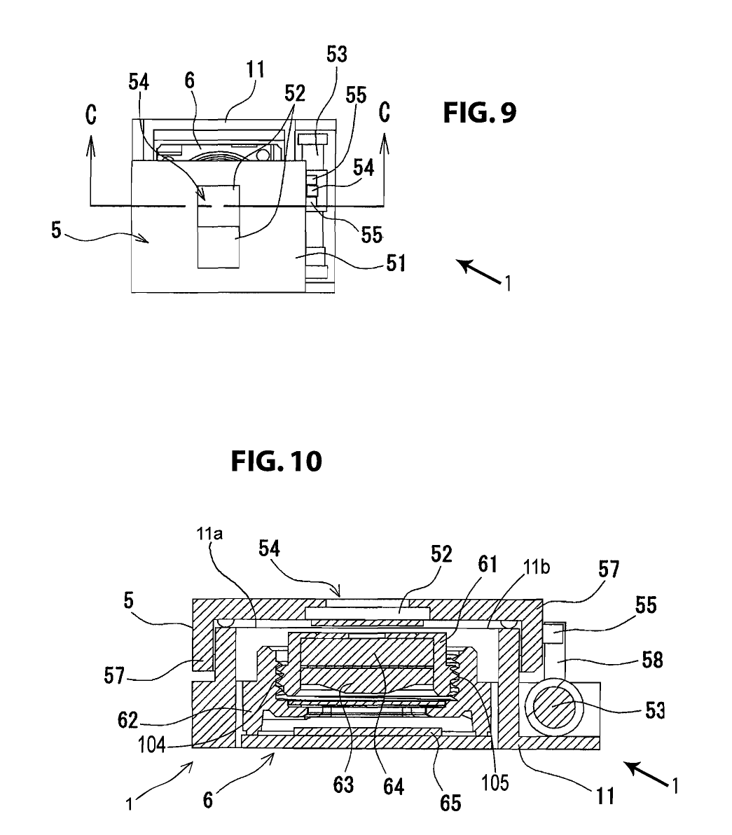

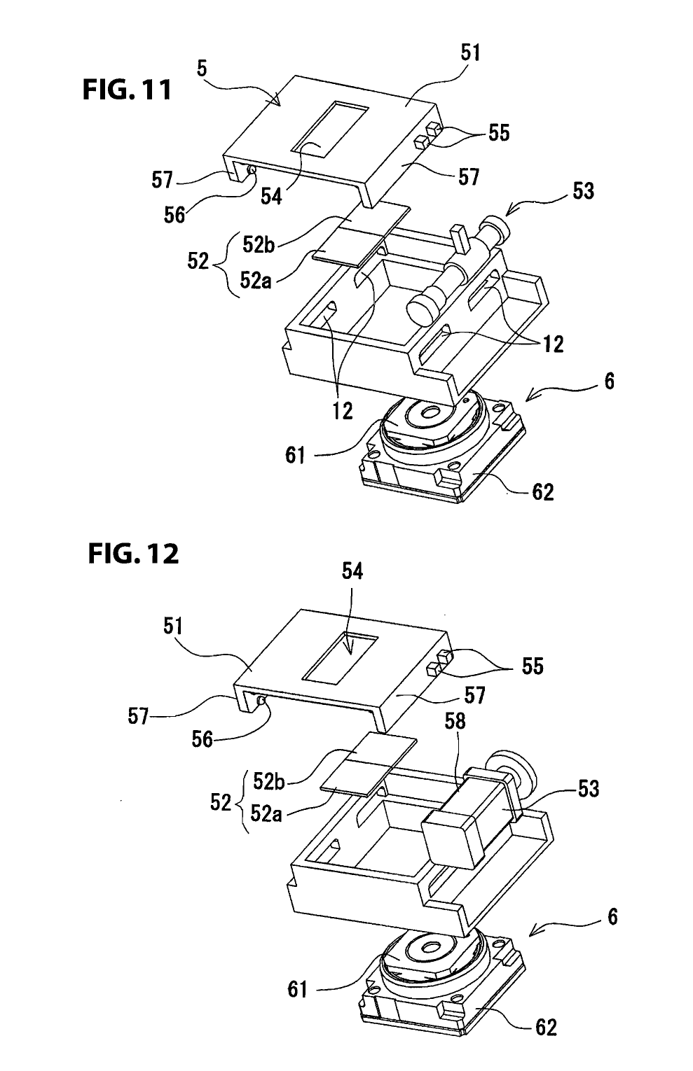

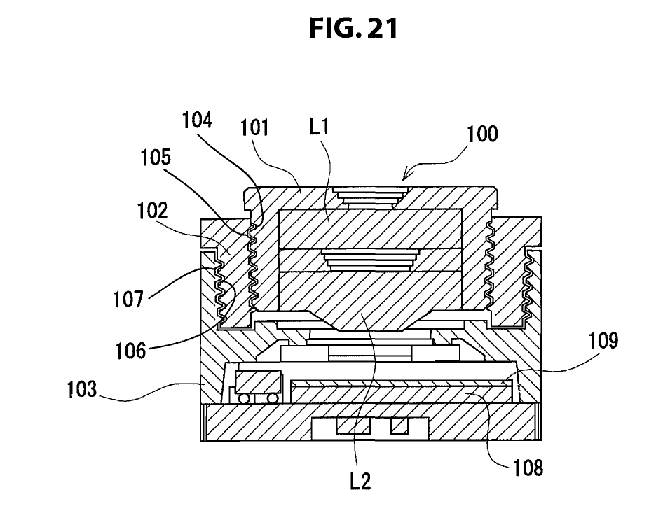

With reference to FIGS. 8 through 11, a camera module 1 is substantially similar to the embodiment previously described, but the filter unit main body 51 is provided on the outside of the lens unit 2. With this configuration, it is possible to apply the present invention capable of imaging a plurality of wavelength ranges to a conventional visible light imaging camera module 100 of FIG. 21 as is.

In other words, with the camera module 1 of FIGS. 8 through 10, the housing 11 forms a case shape that includes the conventional camera module 100, and the filter unit main body 51 of the filter unit 5 is constructed so as to be placed and held on the opened upper surface 11a. In addition, the actuator 53¹ is provided on the side part of the housing 11.

As is shown in FIG. 8 through FIG. 11, the housing 11 is formed from a square shaped tube open at the top and bottom surface so as to contain the conventional camera module 100 (called camera module 6 in the following). Furthermore, a set of opposing slide grooves 12 is formed in the side surfaces. The slide grooves 12 are mated to slide protrusions 56 provided on the filter unit main body 51, and these slide protrusions 56 may slide into these slide grooves 12. In addition, an actuator installation part 13 that is capable of having the actuator 53 installed is provided on the outside of one of the sides provided with the slide grooves 12. Furthermore, the housing 11 is secured in a state that contains the camera unit 6, and it is such that in the relative position of the conventional camera unit 6 does not move. Furthermore, the attachment hole 11b is formed in the upper surface 11a of the housing 11 as a hole that makes the imaging light incident to the camera unit 6 in a position in internal to the camera unit 6. Therefore, the attachment hole 11b is simply an incident light hole rather than a hole for attaching something.

The camera unit 6 is the conventional camera module 100, and is shown in FIG. 10, ¹ Actuator installation part 13 is not shown in the figures.

it comprises a lens module 61 where a lens that is the same as in Embodiment 1 is built in and a pedestal 62 for attaching the lens module 61 provided on the outside of the lens module 61.

The lens module 61 has a cylindrical shape, and a lens 63 and a lens 64 are installed on the inside. In addition, a screw thread 104 is provided on the cylindrical surface of a lens module 61.

The pedestal 62 has a female screw thread 105 formed helically on the inside cylindrical surface so as to screw tightly to the lens module 61. The lens module 61 is attached to the pedestal 62 by tightly screwing this female screw thread 105 to the male screw thread 104 on the outside cylindrical surface of the lens module 61.

Furthermore, the pedestal 62 secures a light receiving unit 65 to a base of the cylindrical space. This light receiving unit may be the same as the sensor unit 3 in Embodiment 1.

The camera unit 6 has the attachment position of the lens module 61 adjusted in the manufacturing process by tightly screwing the pedestal 62 and the lens module 61, and the focus is adjusted so that the image from the lens module 61 may be formed on the light receiving unit 65.

The filter unit 5 comprises the filter unit main body 51 formed so as to have a plate shape with a U-shaped cross-sectional view, a light filter 52 that is substantially similar to 1 and the actuator 53. The installation hole 54 is formed in the same manner as in previously described in the middle of the plate shape surface of the filter unit main body 51.

The filter unit main body 51 that forms a U-shape has a shape for installation on the housing 11 where standing walls 57 are positioned on the outside of the side walls in which are formed the slide grooves 12 in the housing 11, and the sliding protrusions 56 are provided so as to protrude on the inside surface of these standing walls 57. The sliding protrusions 56 are provided so as to protrude into a position inside of the sliding grooves 12 formed in the housing 11, and the filter unit main body 51 is made to be able to slide on the upper surface of the housing 11 in a plane perpendicular to the light path in a state where the slide protrusions 56 are mated with the slide grooves 12 in the housing 11. In addition, the actuator 53 is secured to the outside surface of one of the standing walls 57, and the securing protruding part 55 is provided so as to protrude so that there can be sliding movement by the actuator 53. This securing protruding part 55 may be affixed to the actuator 53 by an adhesive or the like in as previously described, but in the present embodiment is configured as two protruding parts 55 with a space, and a protrusion 58 provided on the actuator 53 that is inserted and secured between these two protruding parts 55, making sliding of the filter unit embodying 51 possible.

The actuator 53 is formed from a piezo actuator as previously described, and the latching protrusion 58² is provided so as to protrude on the part of actuator 53 that is moved when it operates. This protrusion 58 engages with the protruding parts 55 provided on the filter unit main body 51, and when the actuator 53 operates, the filter unit main body 51 slides and moves on the upper surface of the housing 11. It is set and secured to the side part on one or more of the slide grooves 12 provided in the housing 11. The other aspects of the actuator 53 are the same previously described.

In addition, the light filters 52 of the filter unit 5 are substantially similar to the previously-described embodiment.

The camera module 1 for the present embodiment has the position of the light filters 52 in the filter unit 5 moved by the actuator 53, and the desired light filter 52 of either the infrared range like cutting filter 52a or the visible range like cutting filter 52b is positioned in the light path before the camera unit 6 for the light path of the imaging light.

Therefore, the imaging light passes through the light filter 52 before entering the lens module 61. ² Features of latching protrusions 58 not visibly shown in FIG. 12.

In another example of the present invention as shown in FIG. 12, the piezo actuator 53 is replaced by a solenoid actuator 53, and the actuator 53 moves the filter unit main body 51 using the solenoid.

Another embodiment of the present invention will be described with reference to the drawings.

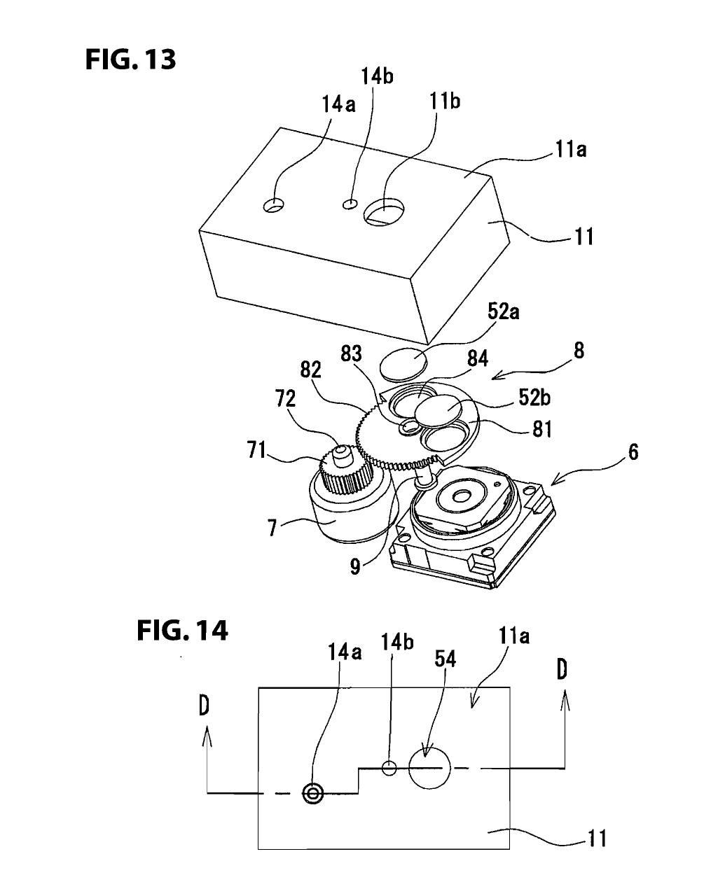

In FIGS. 13 through 15, a camera module 1 is shown as an example in which the switching of the light filters 52 is carried out mechanically on the outside of the lens unit 2, and the camera unit 6 is the substantially similar to the camera unit 6 of the previous embodiment.

The housing 11 has a box shape, and inside the housing 11 are a motor 7 that provides a drive force for the filter unit 5 and a gear unit 8 that transfers the drive force of the motor 7, rotating and moving the filter unit 5. The attachment hole 11b opens as an incident light hole for the imaging light in a position opposed to the lens module 61 of the camera unit 6. Therefore, the imaging light reaches the lens module 61 installed at the bottom of the attachment hole 11b through the attachment hole 11b.

In addition, fitting holes 14a, 14b, which are respectively capable of supporting the motor 7 shaft and the components of the gear unit 8, are formed in the upper surface 11a of the housing 11.

The motor 7 may be formed from a stepping motor, and rotation of a rotary angle of a desired amount is possible. A gear 71 is attached to the rotary shaft of the motor 7 transfers the drive force of the motor 7 to the gear unit 8. In addition, a rotary shaft 72 is supported by the fitting hole 14a formed in the upper surface 11a of the housing 11 and fixed in position.

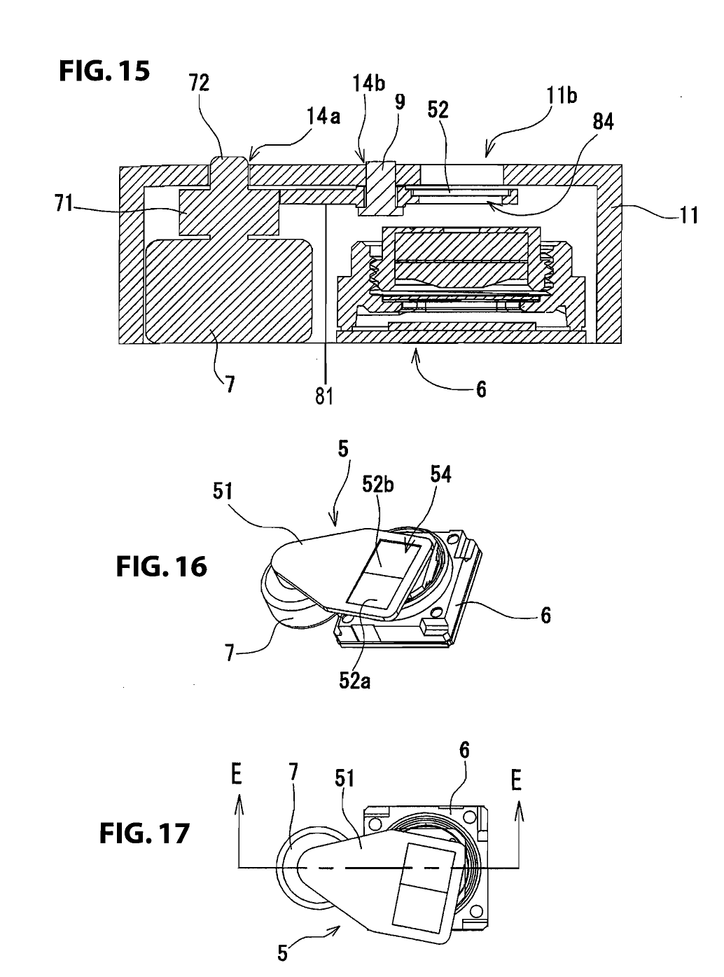

The gear unit 8 includes a filter unit 5 which is operating by the drive force of the motor 7. A unit main body 81 has a round, plate shaped body as is shown in FIG. 13 and FIG. 15, and substantially on each half circle of the main body 81 is an arc with a different diameter formed on the periphery, with a center hole 83 formed in the center. A pin 9 for attachment is inserted into the fitting hole 14b in a state where it fits with free play and is served to the fitting hole 14b, making it possible to attach the gear unit 8 on the inside of the upper surface of the housing 11. Furthermore, a circumferential gear 82 is provided on the peripheral part with the smaller diameter. This circumferential gear 82 is such that it meshes with the gear 72 of the motor 7 in a state where the gear unit 8 attaches to the inside of the upper surface 11a of the housing 11. Two installation holes 84 capable of fitting the light filters 52 are formed so as to have, for example, circular shapes on the surface on the other side of the peripheral part with the large diameter. Therefore, when the gear unit 8 is rotated by the gear 71 and the circumstantial gear 82 because of the drive force of the motor 7, the two installation holes 84 may be alternatively rotated to the same position. The motor 7 is driven and controlled in such manner that the two light filters 52 placed in the installation holes 84 are switched.

In the present embodiment of the disclosed inventions, the infrared range light cutting filter 52a and the visible range light cutting filter 52b, which together comprise the light filters 52, are provided, for example, in a round shape matched to each of the installation holes 84. Furthermore, in contrast the previously embodiments, they are disposed without coming into contact with each other. Naturally, the configuration may be such that the installation holes 84 are placed at a very small distance without being formed adjacently, but suitable adjustments may be made using the angle of rotation of the stepping motor, the area of the light filters 52 and the like.

In the present embodiment, switching the light filters 52 is mechanically controlled by the motor 7a and the gear 82 of gear unit 8.

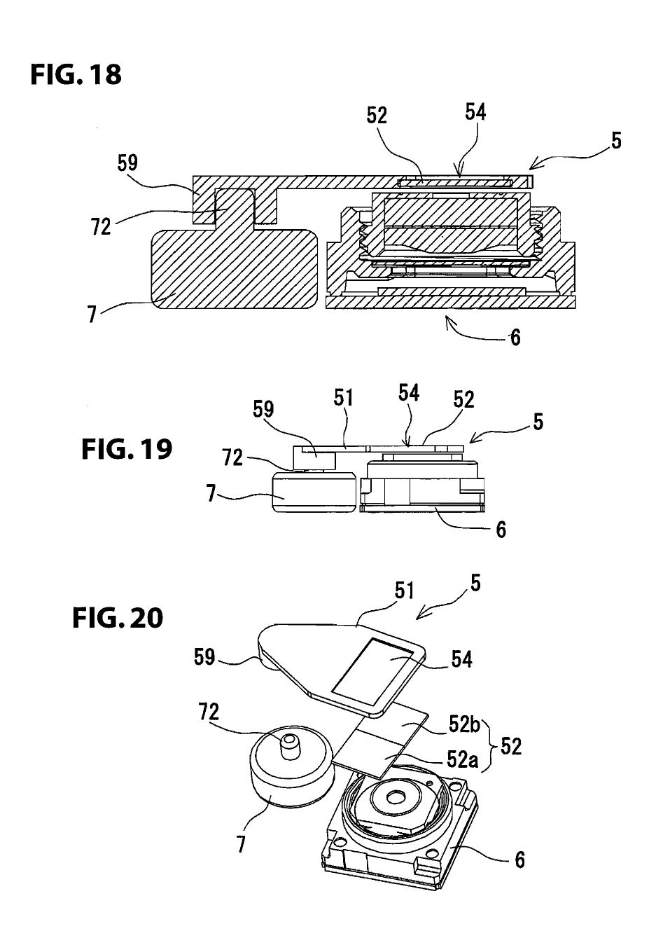

FIGS. 16 through 20 illustrate another embodiment of the present invention.

In the embodiment illustrated by FIGS. 16 through 20, the filter unit 5 uses a motor 7 in the same manner as in the previous embodiment to switch light filter 52 by rotary movement. Camera module 6, which may for example be conventional camera module 100, is included, and the light filters 52 are switched externally from of the lens unit 2 of camera module 6.

Motor 7 may for example be a stepping motor, capable of movement in a prescribed angle of rotation and disposed and secured in the neighborhood of the camera unit 6. A rotary shaft 72 of the motor 7 may be controlled at an extremely small angle of rotation less than one rotation, so that the light filters 52 of the filter unit 5 may be adjacent and disposed in contact on a long side of each filler 52a, 52b as in the previously described embodiment.

The filter unit main body 51 of the filter unit 5 is formed, for example, from a plate shaped body, and one edge of the filter unit main body 51 forms an attachment part 59 that is secured to the rotary shaft 72 of the motor 7. By this means, the filter unit main body 15 may be supported by the motor 7 so as to be able to rotate.

In addition, an installation hole 54 as for the previously described embodiments is formed on a swinging edge side surface of the filter unit main body 51 that is rotated, such that the light filters 52 may be placed and secured in the installation hole 54.

As illustrated for the previously described embodiments, each piece of equipment in which the inactive camera module may be disposed is presumed to have conventional substrates affixed for the disposing of the camera module 1.

The present invention may be used in electronic equipment such as mobile telephones, and is particularly effective for use in electronic equipment and the like where it is desired that imaging of a plurality of lights such as infrared light and visible light is carried out with a single camera module.

What is claimed is:

1. A camera module comprising
a lens unit with an internal lens that refracts light that enters and passes it through to an opposed surface;
a housing having a photosensitive element in a base part and configured to attach the lens unit so as to be in opposition with the photosensitive element; and
a filter unit, in which there are disposed a plurality of adjacent light cut filters with different cut wavelengths and including a switching unit for switching among the plurality of adjacent light cut filters to provide an active light cut filter, the filter unit being disposed such that the imaging light passes through the active light cut filter reaching the photosensitive element from a photographic subject

2. The camera module according to claim 1, wherein said light cut filters are thin plates having a rectangular shape, and the adjacent light cut filters are arranged to be continuous with each other on the long side.

3. The camera module according to claim 1 wherein said light cut filters are configures such that a difference in focal distance to the photosensitive element is made uniform according to the difference in wavelength for each of ultraviolet light, visible light and infrared light by differences in the thickness of said filters.

4. The camera module according to claim 1, wherein said light cut filters are constituted such that a difference in focal distance to the photosensitive element is made uniform according to the difference in wavelength for each of ultraviolet light, visible light and infrared light by differences in the constituent materials for said filters.

5. The camera module according to claim 1, wherein the filter unit is disposed between the lens unit and the photosensitive element.

6. The camera module according to claim 1, wherein the filter unit is disposed on an opposite side of the lens unit from the photosensitive element.

7. The camera module according to claim 2, wherein the switching unit further comprises:
a main body for housing the plurality of adjacent light cut filters; and
an actuator for linearly transposing the main body so that a selected one of the plurality of adjacent light cut filters is the active light cut filter.

8. The camera module according to claim 7, wherein the actuator includes a piezoelectric element.

9. The camera module according to claim 7, wherein the actuator includes a solenoid.

10. The camera module according to claim 1, wherein the switching unit further comprises:
a main body for housing the plurality of adjacent light cut filters; and
an actuator for rotatably transposing the main body so that a selected one of the plurality of adjacent light cut filters is the active light cut filter.

11. The camera module according to claim 10, wherein:
the main body comprises a round plate-shaped body including a circumferential gear on at least a portion of the round plate-shaped body and a plurality of installation holes on a surface of the round plate-shaped body for receiving the plurality of adjacent light cut filters; and
the actuator comprises a motor for driving a drive gear, the drive gear being engaged with the circumferential gear of the main body.

12. The camera module according to claim 10, wherein:
the main body comprises a plate-shaped body including one or more installation holes on a surface of the plate-shaped body for receiving the plurality of adjacent light cut filters; and
the actuator comprises a motor for rotatably transposing the main body, the motor having an axle that is affixed to a rotational center of the plate shaped body so that rotation of the axle by the motor rotatably transposing the main body.

13. The camera module according to claim 12, wherein:
the main body comprises one rectangular installation hole; and
the plurality of adjacent light cut filters are thin plates having a rectangular shape, and are arranged to be continuous with each other along the long sides of the thin plates and mounted in the one rectangular installation hole.
